(19) United States
(12) Patent Application Publication
(10) Pub. No.: US 2008/0235748 A1
(43) Pub. Date: Sep. 25, 2008

(54) TRANSMITTING AND RECEIVING METHOD AND APPARATUS FOR DIGITAL TELEVISION BROADCASTING DATA

(75) Inventor: Sung-il PARK, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/045,857

(22) Filed: Mar. 11, 2008

Related U.S. Application Data
(60) Provisional application No. 60/907,064, filed on Mar. 19, 2007.

(30) Foreign Application Priority Data
May 28, 2007 (KR) 10-2007-0051586

(51) Int. Cl. H04N 7/173

(52) U.S. Cl. 725/114; 725/105; 725/131

(57) ABSTRACT

Provided are an apparatus and method for reducing power consumption by selectively turning off frame receiving while undesired service is transmitted. The method includes generating a service frame group including all service frames and designating the frame number for service frames so that a radio frequency (RF) receiving unit operates while receiving the service frames corresponding to a desired service and the power of the RF receiving unit is turned off while the service frames corresponding to an undesired service are transmitted, thereby saving power. In addition, the power of the RF device is continuously turned off during various frames so that the RF device can rest for a longer period of time and thus power saving efficiency is excellent.

### CROSS-REFERENCE TO RELATED PATENT APPLICATION

This application claims priority from U.S. Provisional Patent Application No. 60/907,064, filed on Mar. 19, 2007, in the U.S. Patent and Trademark Office, and priority from Korean Patent Application No. 10-2007-0051586, filed on May 28, 2007, in the Korean Intellectual Property Office, the disclosures of which are incorporated herein by reference in their entirety.

### BACKGROUND OF THE INVENTION

1. Field of the Invention

Apparatuses and methods consistent with the present invention relate to digital television broadcasting, and more particularly, to digital television broadcasting which reduces power consumption by selectively turning off frame receiving while an undesired service is transmitted.

2. Description of the Related Art

According to the old paradigm, a television broadcast is watched from a fixed position. However, such a paradigm is currently changing, i.e., a user can watch a television broadcast anywhere at any time. In order to adjust to the change in the way an audience watches a television broadcast, businesses and manufacturers are trying to produce standards and terminals suitable for a mobile environment.

Such standards and terminals should be designed by considering a specific mobile environment. That is, a mobile terminal provides a service to a user by using a limited battery resource. Therefore, while providing a service according to regulations, the standards and terminals should be designed to provide a service using the minimum battery resources. In order to reduce power consumption of the terminals, there is a need in the technology to turn off the power of a radio frequency (RF) device while service that is not selected by a user is being transmitted.

### SUMMARY OF THE INVENTION

The present invention provides a method and apparatus for transmitting digital television broadcasting data to reduce power consumption by selectively turning off a frame receiving apparatus while a service that is not desired by a user is transmitted, and a computer readable recording medium having embodied thereon a computer program for executing the method of transmitting digital television broadcasting data.

The present invention also provides a method and apparatus for receiving digital television broadcasting data to reduce power consumption by selectively turning off a frame receiving apparatus while a service that is not desired by a user is transmitted, and a computer readable recording medium having embodied thereon a computer program for executing the method of receiving digital television broadcasting.

According to an aspect of the present invention, there is provided a method of transmitting digital television broadcasting data, the method including: generating or allocating at least one service frame with respect to respective services included in a channel, designating a frame number for the at least one generated or allocated service frame; generating a service frame group including all service frames for which the frame number is designated, and transmitting the service frame group.

In the designating of the frame number, a frame number 1 may be designated to a first service frame in the service frame group and the frame number is incremented by 1 for the next service frame.

The generating of the service frame groups may include: generating service configuration information for the service frame group, and adding the service configuration information to the at least one generated or allocated service frame, wherein the service configuration information indicates to which service of the channel each service frame corresponds.

According to another aspect of the present invention, there is provided an apparatus for transmitting digital television broadcasting data, the apparatus including: a service frame generating unit which generates or allocates at least one service frame with respect to respective services included in a channel, a frame number determining unit which designates a frame number for the at least one generated or allocated service frame, a service frame group generating unit which generates a service frame group including all service frames for which the frame number is designated, and a transmitting unit which transmits the service frame group.

According to another aspect of the present invention, there is provided a method of receiving digital television broadcasting data, the method including: analyzing service configuration information for a service frame group, determining a frame number of at least one service frame that corresponds to a desired service based on the analyzed service configuration information, receiving the at least one service frame having the determined frame number from among the service frames included in the service frame group, and turning off the power of a radio frequency (RF) device to receive a service frame while service frames which do not have the determined frame number are transmitted.

In the frame number of the service frames, a frame number 1 may be designated to a first service frame in the service frame group and the frame number is incremented by 1 for the next service frame.

The service configuration information may indicate to which service of the channel each service frame corresponds.

The turning off the power of the RF device may include: determining a number of service frames that do not correspond to the desired service from among the service frames included in the service frame group, determining a time to turn off the power of the RF device by multiplying a length of a single service frame by the determined number of the service frames, and receiving the last service frame from among the service frames corresponding to the desired service and turning off the power of the RF device during the determined time.

According to another aspect of the present invention, there is provided an apparatus for receiving digital television broadcasting data, the apparatus including: a service configuration information interpreting unit which analyzes service configuration information for a service frame group and determined a frame number of at least one service frame that corresponds to a desired service based on the analyzed service configuration information, a radio frequency (RF) receiving unit which receives the service frame having the determined frame number from among the service frames included in the service frame group, and an RF power control unit which turns off the power of the RF receiving unit while service frames which do not have the determined frame number are transmitted.

In the frame number of the service frames, a frame number 1 may be designated to a first service frame in the service frame group and the frame number is incremented by 1 for the next service frame.

The service configuration information may indicate to which service of the channel each service frame corresponds.

The RF power control unit may include: an off-time determining unit which determines a number of service frames that do not correspond to the desired service from among the service frames included in the service frame group and determine a time to turn off the power of the RF receiving unit by multiplying a length of a single frame by the number of the service frames, and an off-time timer unit which receives the last service frame from among the service frames corresponding to the desired service and turns off the power of the RF receiving unit during the determined time.

### BRIEF DESCRIPTION OF THE DRAWINGS

The above and other aspects of the present invention will become more apparent by describing in detail exemplary embodiments thereof with reference to the attached drawings in which:

FIG. 1 is a diagram of a related art Advanced Television Systems Committee (ATSC) channel system;

FIG. 2 is a diagram of an ATSC channel system improved according to an exemplary embodiment of the present invention;

FIG. 3 is a diagram of service frame groups according to an exemplary embodiment of the present invention;

FIG. 4 is a block diagram of an apparatus for transmitting digital television broadcasting data according to an exemplary embodiment of the present invention;

FIG. 5 is a block diagram of an apparatus for receiving digital television broadcasting data according to an exemplary embodiment of the present invention;

FIG. 6 is a block diagram of an apparatus for transmitting digital television broadcasting data according to another exemplary embodiment of the present invention;

FIG. 7 is a block diagram of an apparatus for receiving digital television broadcasting data according to another exemplary embodiment of the present invention;

FIG. 8 is a flowchart of a method of receiving digital television broadcasting data according to another exemplary embodiment of the present invention;

FIG. 9 is a diagram of a protocol stack of an Advanced-Vestigial Side Band (A-VSB) system;

FIG. 10 shows an example in which a method of transmitting data according to an exemplary embodiment of the present invention is applied to the A-VSB system of FIG. 9;

FIG. 11 is a diagram of a format of SIC according to an exemplary embodiment of the present invention;

FIG. 12 shows the format of the SIC of FIG. 11 in more detail according to an exemplary embodiment of the present invention;

FIG. 13 shows contents of frame_group_information according to an exemplary embodiment of the present invention;

FIG. 14 shows version_indicator_information according to an exemplary embodiment of the present invention;

FIG. 15 shows additional_service_information according to an exemplary embodiment of the present invention; and

FIG. 16 shows turbo_channel_information according to an exemplary embodiment of the present invention.

### DETAILED DESCRIPTION OF THE INVENTION

Hereinafter, the present invention will be described more fully with reference to the accompanying drawings, in which exemplary embodiments of the invention are shown.

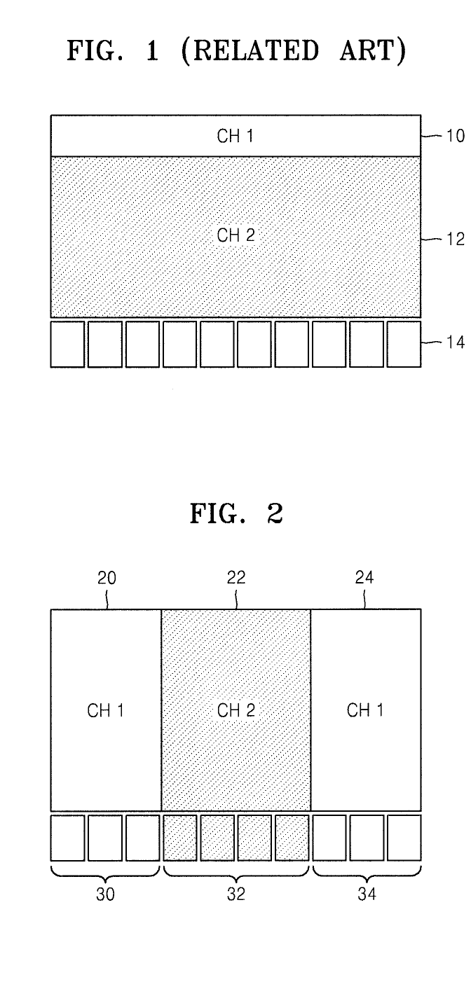

FIG. 1 is a diagram of a related art Advanced Television Systems Committee (ATSC) channel system. The ATSC is a committee established to develop an Advanced Television (ATV) method that should be the next generation terrestrial television in the United States. The ATSC channel system is a technical standard of the next generation digital terrestrial television method in the United States.

Referring to FIG. 1, channel 1 (CH 1, 10) and channel 2 (CH 2, 12) are interleaved in frames 14. That is, data of these channels is spread out in radio frequency (RF) frames. Therefore, there is no way to control the power of an RF device selectively for a specific service provided by a channel.

FIG. 2 is a diagram of an ATSC channel system improved according to an exemplary embodiment of the present invention.

Referring to FIG. 2, in the system according to this exemplary embodiment of the present invention, channel 1 (CH 1, 20 and 24) and channel 2 (CH 2, 22) are divided into each frame to be transmitted. In FIG. 2, channel 1 (20 and 24) is transmitted by using frames 30 and 34 and channel 2 (22) is transmitted by using frames 32. Accordingly, if a desired service from a receiving apparatus corresponds to channel 1, the frames 32 which are the frames corresponding to channel 2 are not received and thus power consumption of the RF device can be reduced.

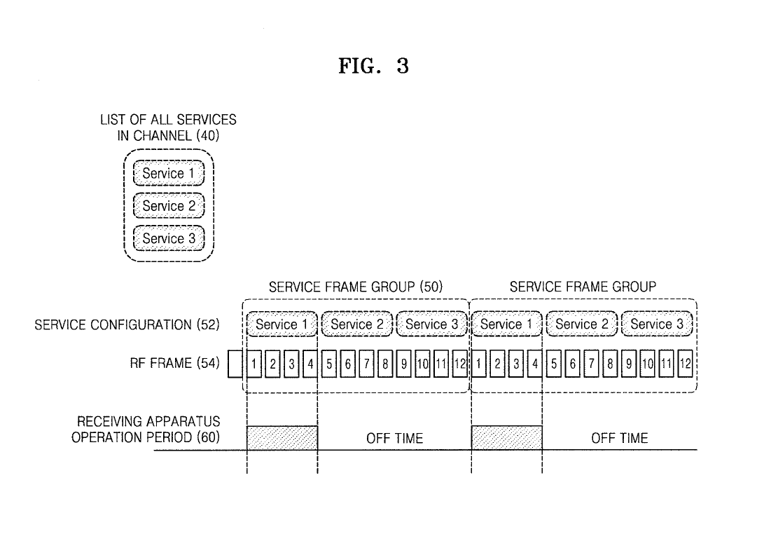

FIG. 3 is a diagram of service frame groups according to an exemplary embodiment of the present invention.

In the present exemplary embodiment, the power consumption of the receiving apparatus can be reduced by using such service frame groups.

In FIG. 3, three services 40 including service 1 through service 3 are included in a channel.

In a method of transmitting digital television broadcasting data according to the present exemplary embodiment, a service frame group 50 including all services to be transmitted is generated. Each service corresponds to at least one RF frame 54. The RF frame that corresponds to each service is referred to as a service frame.

In FIG. 3, service 1 corresponds to service frames 1 through 4, service 2 corresponds to service frames 5 through 8, and service 3 corresponds to service frames 9 through 12, as shown by the service configuration information 52.

FIG. 3 illustrates that service 1 is received from a reception side.

According to a receiving apparatus operation period 60, the receiving apparatus should receive the service frames 1 through 4 that correspond to service 1. Thus, while the service frames 5 through 12 are transmitted, the receiving apparatus is turned off In this exemplary embodiment, the RF device included in the receiving apparatus is turned off.

After the service frames 1 through 12 are transmitted, a next service frame group is transmitted. When service frame 1 included in a new service frame group is transmitted, the power is supplied to the RF device of the receiving apparatus so that service frames can be received. Thus, the time to turn off the RF device is previously determined so as to turn off the power of the RF device during the determined off time.

In order to previously determine the time to turn off the RF device, service configuration information is generated and transmitted from a transmission device to the receiving apparatus. The service configuration information indicates correspondence information between services rendered and channel frames. In other words, the service configuration information indicates to which service of the channel, each service frame corresponds. Using the service configuration information, the reception side may know that service 1 corresponds to the service frames 1 through 4 from among all service frames. Since all service frames comprise service frames 1 through 12, service frames 5 through 12 correspond to the time to turn off the RF device. Accordingly, the time to turn off the RF device may be determined by Equation 1 shown below. According to circumstances, the time to turn off may be reduced by α. That is, when the RF device needs the preparation time to receive an RF stream or if the clock of a terminal is not accurate so that an error exists, an operation that is earlier than the predetermined off time may be needed. Such a preparation time is represented as α.

Off time of the RF device=(number of all service frames included in a service frame group−number of service frames corresponding to desired service)*length of a single frame−α [Equation 1]

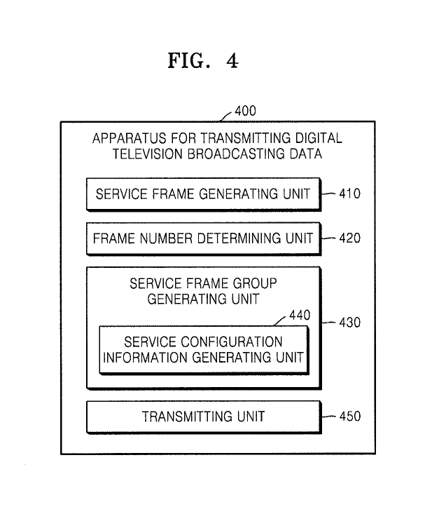

FIG. 4 is a block diagram of an apparatus for transmitting digital television broadcasting data according to an exemplary embodiment of the present invention.

Referring to FIG. 4, the apparatus for transmitting digital television broadcasting data 400 includes a service frame generating unit 410, a frame number determining unit 420, a service frame group generating unit 430, and a transmitting unit 450.

The service frame generating unit 410 generates at least one service frame with respect to each service included in a channel.

The frame number determining unit 420 determines frame numbers with respect to the generated service frames.

The service frame group generating unit 430 generates service frame groups including all service frames generated by the service frame generating unit 410. The service frame group generating unit 430 may further include a service configuration information generating unit 440 which generates service configuration information to be added to each service frame. The service configuration information indicates to which service of the channel, each service frame included in the service frame groups corresponds.

The transmitting unit 450 transmits the service frame groups.

As an example, the frame number determining unit 420 determines the frame number 1 for the first service frame in the service frame group and determines the number for the next service frame by increasing the frame number by 1.

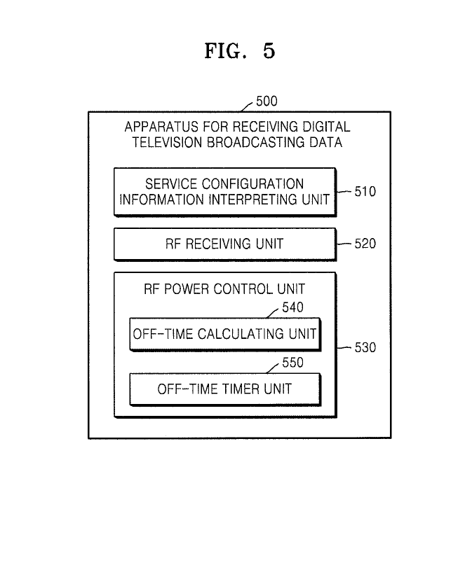

FIG. 5 is a block diagram of an apparatus for receiving digital television broadcasting data according to an exemplary embodiment of the present invention.

Referring to FIG. 5, the apparatus for receiving digital television broadcasting data 500 includes a service configuration information interpreting unit 510, an RF receiving unit 520, and an RF power control unit 530.

The service configuration information interpreting unit 510 interprets the service configuration information for the service frame groups and obtains at least one frame number of the service frames that correspond to a desired service.

The RF receiving unit 520 receives the service frames having the frame number obtained from the service configuration information interpreting unit 510 from among the service frames included in the service frame groups.

While service frames which do not have the frame number obtained from the service configuration information interpreting unit 510 are transmitted, the RF power control unit 530 turns off the power of the RF receiving unit 520. Accordingly, the service frame that corresponds to an undesired service is not received and the power consumption of the RF receiving unit 520 can be reduced.

In FIG. 5, the RF power control unit 530 includes an off-time calculating unit 540 and an off-time timer unit 550.

The off-time calculating unit 540 obtains the number of the service frames which do not correspond to the desired service from among the service frames included in the service frame groups, multiplies a length of a single frame by the number of the service frames, and calculates the time to turn off the power of the RF receiving unit 520. This is same with the time to turn off the RF device as given by Equation 1.

The off-time timer unit 550 receives the last service frame from among the service frames corresponding to the desired service and turns off the power of the RF receiving unit 520 during the time to turn off the RF device determined by the off-time calculating unit 540. Accordingly, after the service frames corresponding to the desired service are all received, the power of the RF receiving unit 520 is turned off and the time according to Equation 1 elapses, and the power of the RF receiving unit 520 is turned on again so that the service frames corresponding to the desired service are received.

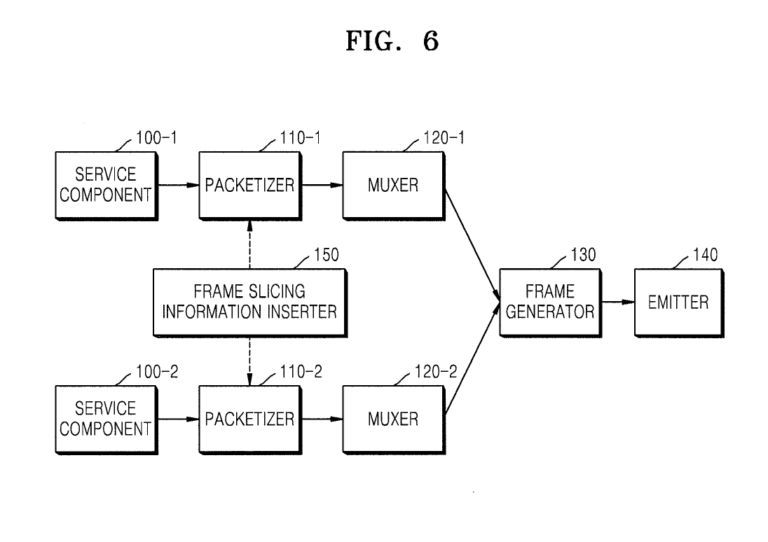

FIG. 6 is a block diagram of an apparatus for transmitting digital television broadcasting data according to another exemplary embodiment of the present invention.

Referring to FIG. 6, the apparatus for transmitting digital television broadcasting data includes service components 100-1 and 100-2, packetizers 110-1 and 110-2, multiplexers 120-1 and 120-2, a frame generator 130, an emitter 140, and a frame slicing information inserter 150.

The service component 100-1 generates an elementary stream (ES) which forms each service. For example, if the service is an A/V service, the component corresponds to an audio component/video component.

The packetizer 110-1 forms each of the ES as a packet. For example, the ES is reformed as a transport stream (TS) packet.

The multiplexer 120-1 multiplexes each of the packets. In the case of the TS, each of the packets is manufactured as one TS.

The frame generator 130 generates frames based on the received multiplexed packets. In the case of an ATSC standard, an interleaving process is performed in order to generate the final frame.

The emitter 140 emits the generated frames by using RF.

The frame slicing information inserter 150 inserts information for frame slicing into the packet. The information for frame slicing is, for example, information including frame numbering information and a table for frame slicing.

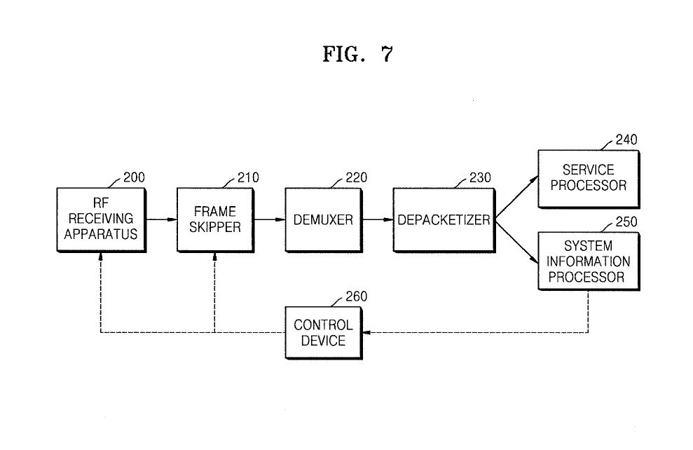

FIG. 7 is a block diagram of an apparatus for receiving digital television broadcasting data according to another exemplary embodiment of the present invention.

Referring to FIG. 7, the apparatus for receiving digital television broadcasting data includes an RF receiving apparatus 200, a frame skipper 210, a demultiplexer 220, a depacketizer 230, a service processor 240, a system information processor 250, and a control device 260.

The RF receiving apparatus 200 receives RF data.

The frame skipper 210 skips the frame corresponding to a service that is not selected by a user.

The multiplexer 220 receives data of the frame and classifies the data into each packet stream.

The depacketizer 230 analyzes the packet according to packet header information and transmits the data to an available decoder.

The service processor 240 is one of ES decoders and provides a service available to a user by decoding the data received from the depacketizer 230. In this exemplary embodiment, the service processor 240 is an ES decoder.

The system information processor 250 receives system information and transmits the information to the control device 260. Examples of the system information include frame slicing information and so on.

The control device 260 receives frame slicing information so as to skip the frame or to control the RF device to not be operated for a certain period of time.

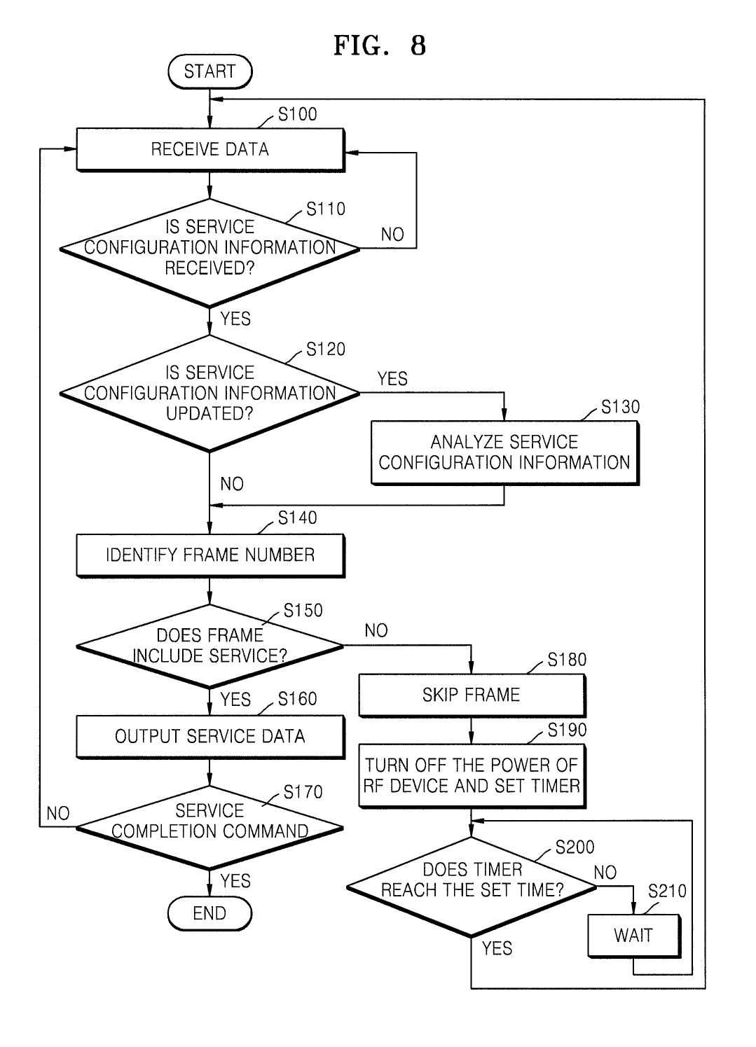

FIG. 8 is a flowchart of a method of receiving digital television broadcasting data according to another exemplary embodiment of the present invention.

In FIG. 8, a process performed by an RF terminal is not illustrated. Instead, a process of receiving an RF frame and the receiving apparatus producing available packet data is illustrated.

First, data is received in operation S100 and whether service configuration information is included in the data is determined in operation S110. If existing service configuration information does not exist and the received data is not the service configuration information, data is received until the service configuration information is received.

If the service configuration information is included in the received data, whether such information is updated compared with the existing forming information is determined in operation S120. If the service configuration information is updated, the service configuration information is analyzed so as to reflect only information that is needed in operation S130.

The frame number determined for the service frame is identified in operation S140 and whether the service frame corresponds to the desired service is determined in operation S150.

If the service frame includes the desired service, service data is output in operation S160. In operation S170, whether a service completion command exists is determined and the above process is repeatedly performed until a service completion command is determined to exist.

If the service frame does not include the desired service, the service frame is skipped in operation S180 and the RF device cannot be operated for a certain period of time.

In order to do so, the power of the RF device is turned off and a timer is set in operation S190. The set time of the timer is the off time according to Equation 1.

Whether the timer reaches the set time is identified in operation S200. If the timer has not reached the set time, time must be allowed to elapse until the timer reaches the set time in operation S210.

When the timer has reached the set time, the power of the RF device is turned on and the above process is repeatedly performed.

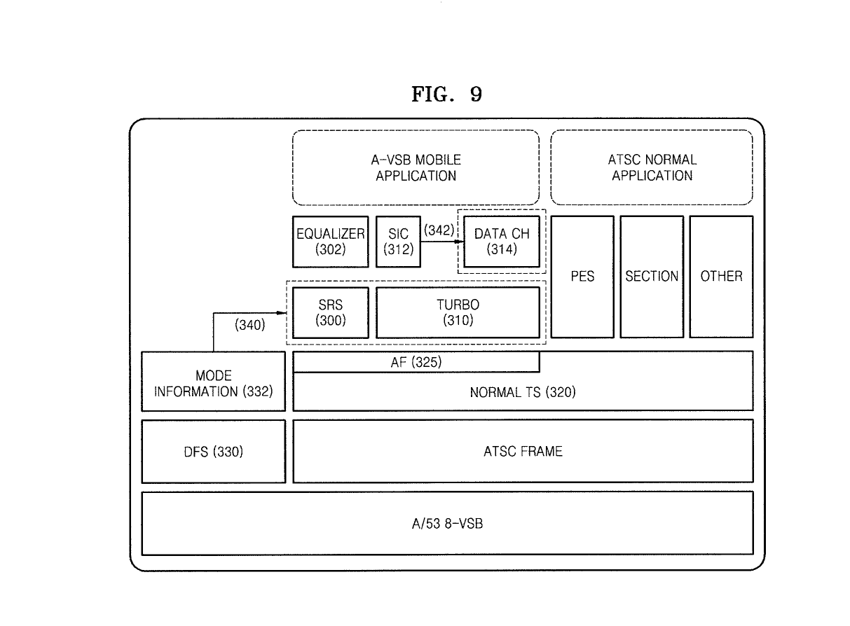

FIG. 9 is a diagram of a protocol stack of an Advanced-Vestigial Side Band (A-VSB) system. The A-VSB system supports a Supplementary Reference System (SRS) and a turbo application. An SRS 300 includes and transmits a training sequence called an equalizer 302 which can increase a reception performance of a terminal.

A turbo application 310 provides a channel which can transmit additional data.

The data of a turbo application 310 is stored in a private data region of an adaptation field (AF) 325 in an ATSC normal TS 320. Information on the SRS 300 and the turbo application 310 is transmitted (as shown by arrow 340) through mode information 332 in the data field sync (DFS) 330. Two DFSs 330 exist in an ATSC transmission frame. The mode information is referred to as information transmitted through the DFS 330.

A part where the turbo application data is transmitted is divided into a signaling information channel (SIC) 312 and data channels 314. Each data channel 314 is divided into sub channels. Information on the sub channels is provided through the SIC 312.

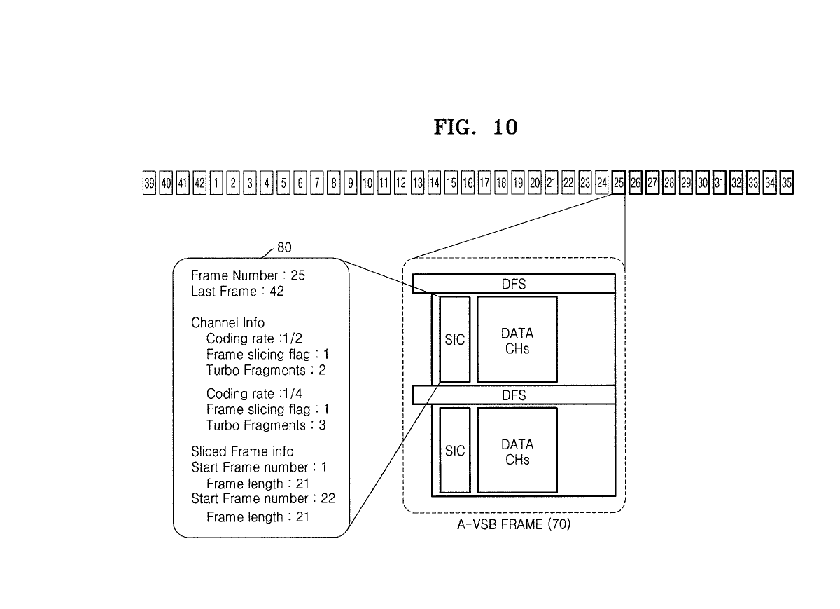

FIG. 10 shows an example in which a method of transmitting data according to an exemplary embodiment of the present invention is applied to the A-VSB system of FIG. 9.

Referring to FIG. 10, each A-VSB frame 70 corresponds to the service frame, the SIC corresponds to the service configuration information, and sliced frames which correspond to the services.

Referring to the example of FIG. 10, contents 80 of the service configuration information (SIC) will now be described.

The frame number of the corresponding frame is 25. The number of all frames is indicated by using the frame number of the last frame in the service frame group and is 42.

A channel includes two services. One service has a coding rate that is ½. Here, the number of a start frame is 1 and the length of all frames is 21. Thus, the service frames from the frame numbers 1 to 21 correspond to a first service.

The other service has a coding rate that is ¼. Here, the number of a start frame is 22 and the length of all frames is 21. Thus, the service frames from the frame numbers 22 to 42 correspond to a second service.

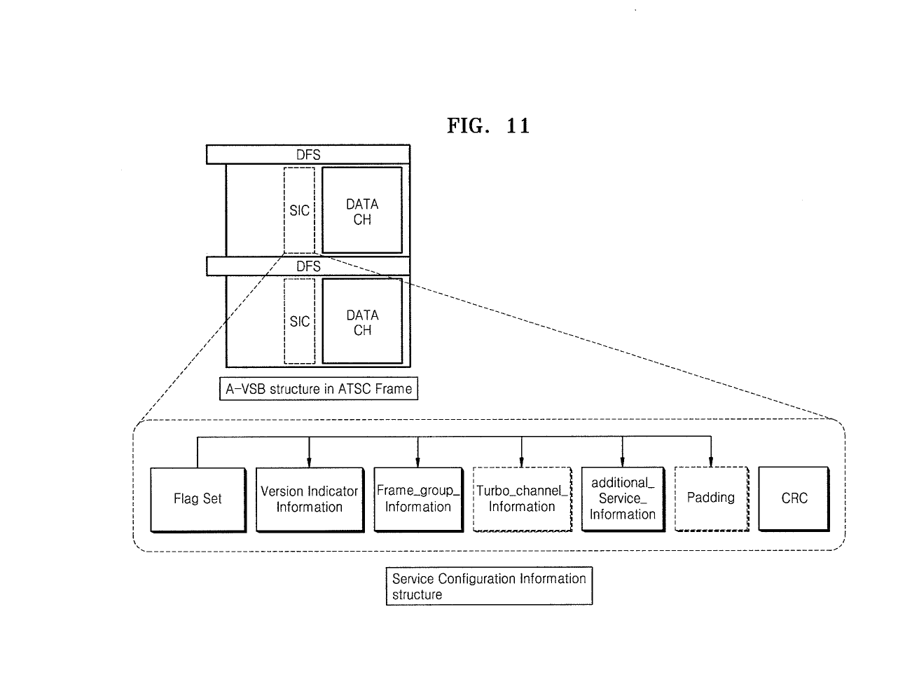

FIG. 11 is a diagram of a format of SIC according to an exemplary embodiment of the present invention.

Referring to FIG. 11, the SIC according to an exemplary embodiment of the present invention includes version indicator information, frame group information, turbo channel information, additional service information, padding, flags indicating the existence of these information, and a cyclic redundancy check (CRC).

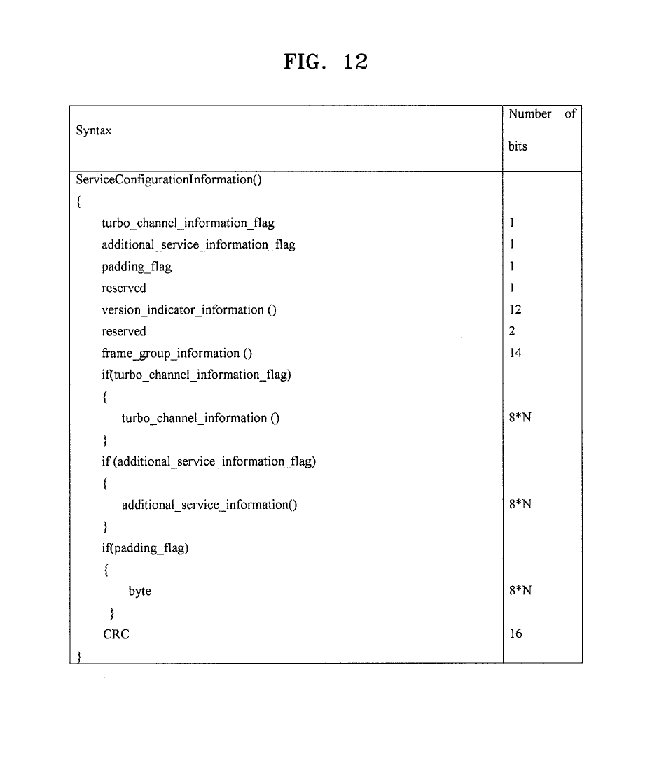

FIG. 12 shows the format of FIG. 11 in more detail.

ServiceConfigurationInformation (SCI) is the smallest unit that is included in the SIC. Only one SCI is included in the SIC of one frame.

In each flag set, turbo_channel_information_flag, additional_service_information_flag, and padding_flag exist.

The turbo_channel_information_flag indicates the existence of turbo_channel_information( ).

The additional_service_information_flag indicates the existence of additional_service_information( ).

The padding_flag indicates the existence of a region of padding.

The frame_group_information will be described more fully below with reference to FIG. 13.

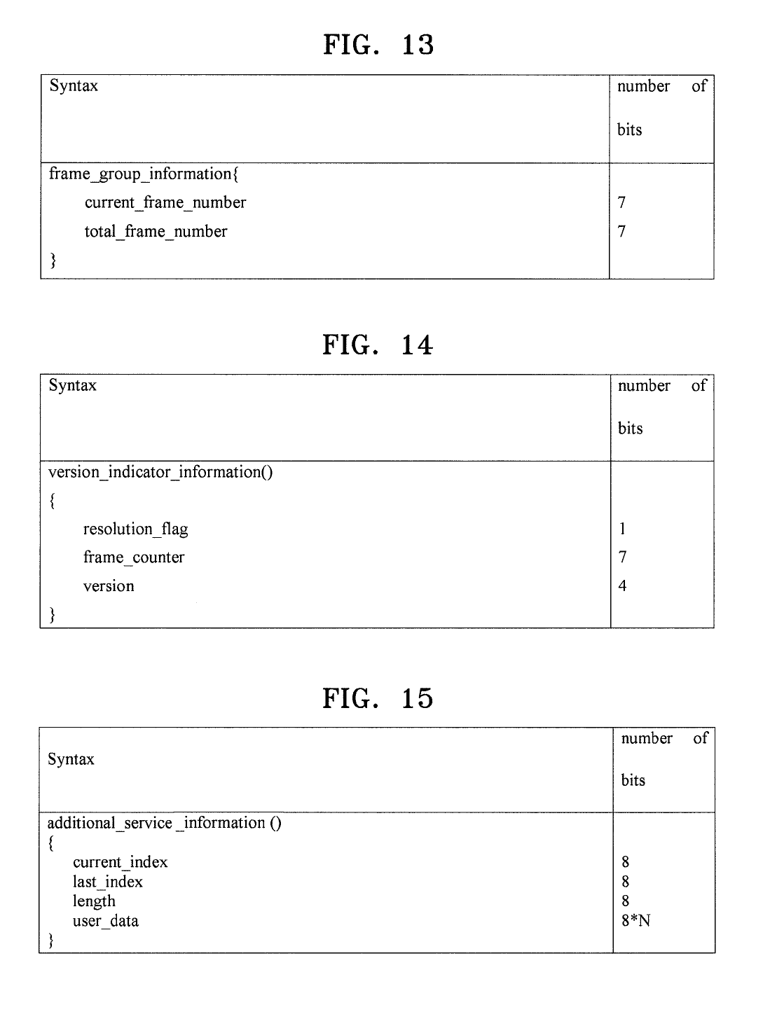

The version_indicator_information will be described more fully later with reference to FIG. 14.

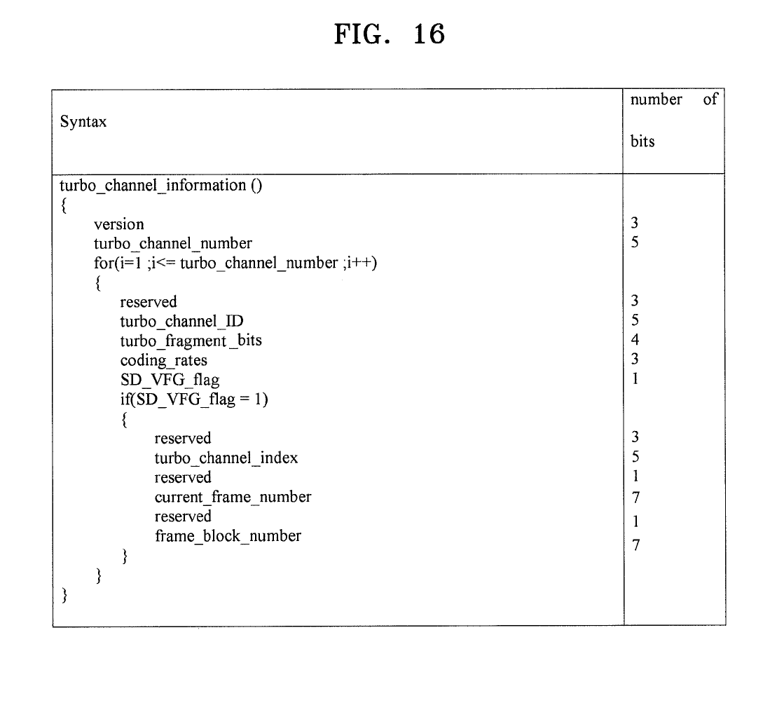

The Turbo_channel_information( ) will be described more fully later with reference to FIG. 16.

An AdditionalServiceDescriptor will be described more fully later with reference to FIG. 15.

A CRC shows an error detection method of the SCI.

FIG. 13 shows contents of frame_group_information.

A current_frame_number indicates a current service frame number.

A total_frame_number indicates the total number of all service frames included in the service frame groups.

Since the A-VSB is a single carrier system, RF frames are provided as an elementary configuration unit that provides a service to support burst transmission. The RF frame is formed of serial lines. Thus, a service allocation method in the frame cannot be used and the RF frames should be divided into divisible groups. Frame grouping is a method of dividing the serial lines of the RF frames into divisible groups.

Examples of frame grouping may include combining a start frame flag and an end frame flag (method 1), including a start frame flag and length information (method 2), and designating the frame number (method 3).

In methods 1 and 2, when the middle frame is received, where the received frame is located from among all frame groups is not known. In addition, when the size of the frame group is changed, it is hardly detected. Method 3 may be used when no such problems as described above exist.

A start of the frame group is designated from frame number 1. Also, after the largest frame number is reached, the number is designated again to frame number 1. This is called wrap up.

The size of the frame group and the length of each service frame can be changed by a signaling procedure in the system. If there is a change in the size of the frame group, a point of time for a service to be repeated can be adjusted. For example, if the size of the frame group is 10 at the point of time when the service starts, 10 frames are needed from the point of time when the first service frame of any service starts to the point of time when the first service frame of the service corresponding to the next service frame group starts. However, if the system information is updated and thus the size of the frame group becomes 20, 20 frames are needed from the point of time when the first service frame of the corresponding service starts to the point of time when the first service frame of the service corresponding to next service frame group is received.

Similarly, if there is a change in the length of the service frame, a point of time for the service to be repeated can be adjusted. The change in the length of the service frame may affect the length of the service frame group. However, according to a method of reducing the length of other service frame, the length of the current service frame may not be changed.

Accordingly, a section to turn off the power of the RF device can be controlled.

FIG. 14 shows version_indicator_information.

Version_indicator_information includes information on whether service configuration information is updated and information indicating when the updating will be accomplished.

Resolution_flag indicates a unit of a frame counter.

As an example, if the value of resolution_flag is 1, the frame counter is a 20 frame unit and if the value of resolution_flag is 0, the frame counter is a 1 frame unit.

Frame_counter indicates the point of time at which updating is to be accomplished as a 1 frame unit or 20 frame unit. The accurate unit changes occur according to the value of resolution_flag.

A version increases a value by 1 each time when service configuration information is updated.

FIG. 15 shows additional_service_information.

Additional_service_information is used to transmit additional service information, in addition to channel description information.

Additional_service_information can be divided into various blocks.

Current_index represents an index of a current block of a descriptor.

Last_index represents an index of a last block of a descriptor.

Length represents a length of a current block.

User_data represents real description data.

FIG. 16 shows turbo_channel_information.

Turbo_channel_information represent configuration information of each channel when data of a turbo application is divided into various channels to be transmitted.

Version represents a version of turbo channel information and the value thereof increases by 1.

Turbo_channel_number represents the number of total turbo channels.

Turbo_channel_ID is information to divide each turbo channel.

Turbo_fragment_bits expresses a length of a turbo channel as an index value.

Coding_rates represents coding rates of a turbo channel.

SD_VFG_flag informs whether SD_VFG (Service Division in a Variable Frame Group) is applied in a turbo channel. When SD_VFG_flag is set, SD_VFG is applied.

SD_VFG is a technique for dividing a turbo channel into an arbitrary number of frame units and transmitting data, that is, transmitting data by the method suggested in an exemplary embodiment of the present invention.

Turbo_channel_index represents the order of a turbo channel.

Current_frame_number represents the number of start frames of a corresponding service.

Frame_block_number represents the number of frames that form a corresponding service.

As described above, in the exemplary embodiments of the present invention, regardless of whether a service can be formed independently in a frame, a system which can turn on/off the power of the RF device of a user terminal is provided. Accordingly, the terminal can be operated longer than a related art terminal. In addition, the power of the RF device is continuously turned off during various frames so that the RF device can rest for a longer period of time and thus power saving efficiency is excellent.

The exemplary embodiments of the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices.

In a method and apparatus for transmitting digital television broadcasting data and a method and apparatus for receiving digital television broadcasting data according to exemplary embodiments of the present invention, service frame groups including all service frames are generated and the frame number for each service frame is designated so that the RF receiving unit operates while receiving the service frames corresponding to a desired service and the power of the RF receiving unit is turned off while receiving the service frames corresponding to an undesired service are transmitted, thereby saving power. In addition, the power of the RF device is continuously turned off during various frames so that the RF device can have a rest for a longer period of time and thus power saving efficiency is excellent. Accordingly, the terminal can be operated for a longer period of time.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of transmitting digital television broadcasting data, the method comprising:
generating or allocating at least one service frame with respect to respective services included in a channel;
designating a frame number for the at least one generated or allocated service frame;
generating a service frame group including all service frames for which the frame number is designated; and
transmitting the service frame group.

2. The method of claim 1, wherein in the designating the frame number, a frame number 1 is designated to a first service frame in the service frame group and the frame number is incremented by 1 for the next service frame.

3. The method of claim 1, wherein the generating the service frame groups comprises:
generating service configuration information for the service frame group; and
adding the service configuration information to the at least one generated or allocated service frame,
wherein the service configuration information indicates to which service of the channel each service frame corresponds.

4. An apparatus for transmitting digital television broadcasting data, the apparatus comprising:
a service frame generating unit which generates or allocates at least one service frame with respect to respective services included in a channel;
a frame number determining unit which designates a frame number for the at least one generated or allocated service frame;
a service frame group generating unit which generates a service frame group including all service frames for which the frame number is designated; and
a transmitting unit which transmits the service frame group.

5. The apparatus of claim 4, wherein the frame number determining unit designates a frame number 1 to a first service frame in the service frame group and the frame number is incremented by 1 for the next service frame.

6. The apparatus of claim 4, wherein the service frame group generating unit further comprises a service configuration information generating unit which generates service configuration information to add to the at least one generated or allocated service frame, wherein the service configuration information indicates to which service of the channel each service frame corresponds.

7. A method of receiving digital television broadcasting data, the method comprising:
determining a frame number of at least one service frame that corresponds to a desired service based on service configuration information for a service frame group;
receiving the at least one service frame having the determined frame number from among the service frames included in the service frame group; and
turning off the power of a radio frequency (RF) device to receive a service frame while service frames which do not have the determined frame number are transmitted.

8. The method of claim 7, wherein in the frame number of the service frames, a frame number 1 is designated to a first service frame in the service frame group and the frame number is incremented by 1 for the next service frame.

9. The method of claim 7, wherein the service configuration information indicates to which service of the channel each service frame corresponds.

10. The method of claim 7, wherein the turning off the power of the RF device comprises:
determining a number of service frames that do not correspond to the desired service from among the service frames included in the service frame group;
determining a time to turn off the power of the RF device by multiplying a length of a single service frame by the determined number of the service frames; and
receiving the last service frame from among the service frames corresponding to the desired service and turning off the power of the RF device during the determined time.

11. An apparatus for receiving digital television broadcasting data, the apparatus comprising:
a service configuration information interpreting unit which determines a frame number of at least one service frame that corresponds to a desired service based on service configuration information of a service frame group;
a radio frequency (RF) receiving unit which receives the service frame having the determined frame number from among the service frames included in the service frame group; and
an RF power control unit which turns off the power of the RF receiving unit while service frames which do not have the determined frame number are transmitted.

12. The apparatus of claim 11, wherein in the frame number of the service frames, a frame number 1 is designated to a first service frame in the service frame group and the frame number is incremented by 1 for the next service frame.

13. The apparatus of claim 11, wherein the service configuration information indicates to which service of the channel each service frame corresponds.

14. The apparatus of claim 11, wherein the RF power control unit comprises:
an off-time determining unit which determines a number of service frames that do not correspond to the desired service from among the service frames included in the service frame group and determine a time to turn off the power of the RF receiving unit by multiplying a length of a single frame by the number of the service frames; and
an off-time timer unit which receives the last service frame from among the service frames corresponding to the desired service and turns off the power of the RF receiving unit during the determined time.

15. A computer readable recording medium having embodied thereon a computer program for executing a method of receiving digital television broadcasting data, wherein the method comprises:
determining a frame number of at least one service frame that corresponds to a desired service based on service configuration information for a service frame group;
receiving the at least one service frame having the determined frame number from among the service frames included in the service frame group; and
turning off the power of a radio frequency (RF) device to receive a service frame while service frames which do not have the determined frame number are transmitted.

16. The computer readable recording medium according to claim 15, wherein in the frame number of the service frames, a frame number 1 is designated to a first service frame in the service frame group and the frame number is incremented by 1 for the next service frame.

17. The computer readable recording medium according to claim 15, wherein the service configuration information indicates to which service of the channel each service frame corresponds.

18. The computer readable recording medium according to claim 15, wherein the turning off the power of the RF device comprises:
determining a number of service frames that do not correspond to the desired service from among the service frames included in the service frame group;
determining a time to turn off the power of the RF device by multiplying a length of a single service frame by the determined number of the service frames; and
receiving the last service frame from among the service frames corresponding to the desired service and turning off the power of the RF device during the determined time.
